(19) United States
(12) Patent Application Publication
(10) Pub. No.: US 2025/0218037 A1
(43) Pub. Date: Jul. 3, 2025

(54) LARGE MODEL-BASED VIDEO PROCESSING METHOD, DEVICE AND STORAGE MEDIUM

(71) Applicant: BEIJING BAIDU NETCOM SCIENCE TECHNOLOGY CO., LTD., Beijing (CN)

(72) Inventors: Yihao LYU, Beijing (CN); Feixiang LU, Beijing (CN); Haotian PENG, Beijing (CN); Longteng LI, Beijing (CN); He JIANG, Beijing (CN); Jingbo ZHOU, Beijing (CN)

(73) Assignee: BEIJING BAIDU NETCOM SCIENCE TECHNOLOGY CO., LTD., Beijing (CN)

(21) Appl. No.: 19/082,573

(22) Filed: Mar. 18, 2025

(30) Foreign Application Priority Data
Dec. 6, 2024 (CN) 202411795369.6

(51) Int. Cl. G06T 7/73; A63B 24/00; A63B 71/06; G06F 16/735; G06V 20/40

(52) U.S. Cl. CPC G06T 7/74; A63B 24/0075; A63B 71/0622; G06F 16/735; G06V 20/41; A63B 2220/05; A63B 2220/806; G06T 2207/10016; G06T 2207/20081; G06T 2207/30196; G06T 2207/30221

(57) ABSTRACT

A large model-based video processing method, device and storage medium in the field of artificial intelligence technology, particularly in the fields of deep learning and large models are disclosed. The specific solution includes: collecting an imitation video made by a user based on a target video; extracting three-dimensional postures of the imitation video using a pre-trained large model based on the imitation video; and performing posture assessment on the imitation video using the pre-trained large model based on the three-dimensional postures of the imitation video and pre-obtained three-dimensional postures of the target video to obtain an assessment result.

### CROSS-REFERENCE TO RELATED APPLICATION

The present application claims the priority and benefit of Chinese Patent Application No. 202411795369.6, filed on Dec. 6, 2024, entitled “Large model-based Video Processing Method, Apparatus, Device and Storage Medium”. The disclosure of the above application is incorporated herein by reference in its entirety.

### TECHNICAL FIELD

The present disclosure relates to the field of computer technology, specifically to the field of artificial intelligence technology, particularly to the fields of deep learning and large models, which may be applied to smart sports and other scenarios; and more particularly to a large model-based video processing method, device and storage medium.

### BACKGROUND

With the high-intensity, high-pressure, and fast-paced lifestyle, people are increasingly recognizing the importance of physical health and paying more attention to physical training.

In existing physical training, users may search for training videos and train independently. To improve the standardization of physical training movements and achieve training effects, users may also seek help from personal trainers, who guide and assess users' physical training, assisting users in completing higher-standard physical training to achieve better training results.

### SUMMARY

The present disclosure provides a large model-based video processing method, device and storage medium.

According to one aspect of the present disclosure, a large model-based video processing method is provided, including: collecting an imitation video made by a user based on a target video; extracting three-dimensional postures of the imitation video using a pre-trained large model based on the imitation video; performing posture assessment on the imitation video using the pre-trained large model based on the three-dimensional postures of the imitation video and pre-obtained three-dimensional postures of the target video to obtain an assessment result.

According to another aspect of the present disclosure, an electronic device is provided, including: at least one processor; and a memory communicatively connected with the at least one processor; where the memory stores instructions executable by the at least one processor, and the instructions, when executed by the at least one processor, cause the at least one processor to perform the method as described above and in any possible implementation.

According to yet another aspect of the present disclosure, a non-transitory computer-readable storage medium storing computer instructions is provided, where the computer instructions, when executed by a computer, cause the computer to perform the method as described above and in any possible implementation.

It should be understood that the content described in this section is not intended to identify key or essential features of the embodiments of the present disclosure, nor is it intended to limit the scope of the present disclosure. Other features of the present disclosure will become easily understood through the following specification.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure;

FIG. 7 is a schematic diagram according to a seventh embodiment of the present disclosure;

FIG. 8 is a schematic diagram according to an eighth embodiment of the present disclosure; and

FIG. 9 is a block diagram of an electronic device for implementing the method of the embodiments of the present disclosure.

### DETAILED DESCRIPTION

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications may be made with respect to the embodiments described herein without departing from the scope and spirit of the present disclosure. Similarly, for clarity and conciseness, the descriptions of the known functions and structures are omitted in the descriptions below.

Obviously, the described embodiments are only part, not all embodiments of the present disclosure. Based on the embodiments in this disclosure, all other embodiments obtained by those skilled in the art without inventive effort fall within the protection scope of the present disclosure.

It should be noted that the terminal devices involved in the embodiments of the present disclosure may include but are not limited to smartphones, Personal Digital Assistants (PDA), wireless handheld devices, Tablet Computers, and other smart devices; display devices may include but are not limited to personal computers, televisions, and other devices with display functions.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

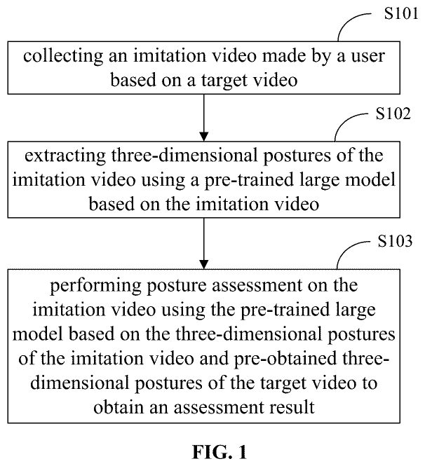

FIG. 1 is a schematic diagram according to a first embodiment of the present disclosure. As shown in FIG. 1, the embodiment provides a large model-based video processing method, which includes:

S101: Collecting an imitation video made by a user based on a target video;

The executing subject of the large model-based video processing method in this embodiment is a large model-based video processing apparatus, which may be an independent electronic entity or a software-integrated application running on devices such as computers and phones to implement physical training processing.

The scenario of this embodiment may be a user training scenario. The target video is pre-obtained before user training and serves as the standard video for user reference. In this embodiment, the training video made by the user based on learning from the target video is called the imitation video.

S102: Extracting three-dimensional postures of the imitation video using a pre-trained large model based on the imitation video;

Since specified positions need to complete specified movements during training, which necessarily leads to changes in the three-dimensional postures of points at specified positions, the three-dimensional postures of the imitation video needs to be extracted for accurate assessment.

The three-dimensional postures of the imitation video in this embodiment may include the three-dimensional postures of keypoints at various positions in the imitation video.

During use, the imitation video is input into the pre-trained large model, which can extract the three-dimensional postures of the imitation video.

S103: Performing posture assessment on the imitation video using the pre-trained large model based on the three-dimensional postures of the imitation video and pre-obtained three-dimensional postures of the target video to obtain an assessment result.

Specifically, the large model may perform comparative analysis of the three-dimensional postures of the imitation video and the three-dimensional postures of the target video to accurately assess the postures of the imitation video, obtain and output the assessment result.

The large model in this embodiment is mainly used to assess the user's training by performing posture assessment on the imitation video.

By adopting the above technical solution, this embodiment of the large model base video processing method can accurately and effectively assess the imitation video based on the three-dimensional postures of the imitation video and pre-obtained three-dimensional postures of the target video.

Optionally, in an embodiment of the present disclosure, step S103 in the above embodiment as shown in FIG. 1 may specifically include the following steps for assessment:

(I) Calculating a posture difference for the three-dimensional postures of the imitation video using the pre-trained large model based on the three-dimensional postures of the imitation video and the three-dimensional postures of the target video;

For example, during specific implementation, for ease of description, video frames in the imitation video are called first video frames, and video frames in the target video are called second video frames.

For each first video frame in the imitation video, a three-dimensional posture difference for a keypoint at a specified position in the first video frame may be obtained based on a three-dimensional posture of the keypoint at the specified position in the first video frame and a three-dimensional posture of a corresponding keypoint at a corresponding specified position in a corresponding second video frame in the target video. For accurate assessment, the imitation video and target video may be aligned before assessment. Then, the first video frame of training start in the imitation video may be aligned with the first video frame of physical training start in the target video. Subsequently, following a similar approach, the imitation video and target video may be analyzed frame by frame for comparison to obtain the three-dimensional posture difference for a keypoint at a specified position in each first video frame of the imitation video.

Then determine an average value of all three-dimensional posture differences for all keypoints at all specified positions in the first video frame as a three-dimensional posture difference for the first video frame; and determine the sum of all three-dimensional posture differences for all the first video frames in the imitation video as the posture difference for the three-dimensional postures of the imitation video.

Using the above method can accurately calculate the posture difference for the three-dimensional posture of the imitation video, to more objectively and accurately represent the difference between the imitation video and the target video.

(II) Performing posture assessment on the imitation video using the pre-trained large model based on the posture difference for the three-dimensional postures of the imitation video to obtain the assessment result.

Specifically, the posture difference for the three-dimensional postures of the imitation video is input into the pre-trained large model, which may perform posture assessment on the imitation video based on the posture difference to obtain and output the assessment result.

By adopting the above technical solution, accurate and effective assessment of the imitation video can be achieved.

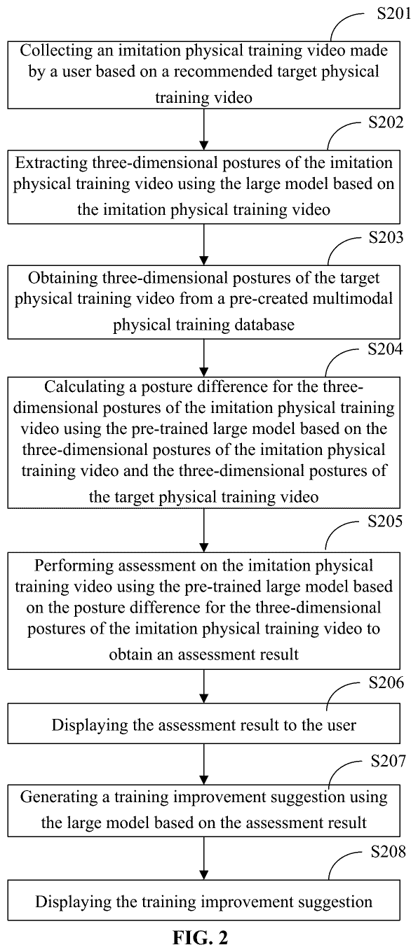

FIG. 2 is a schematic diagram according to a second embodiment of the present disclosure. This embodiment of the large model-based video processing method provides a more detailed description of the technical solution on the basis of the embodiment shown in FIG. 1. In this embodiment, taking the application of the technical solution described in FIG. 1 in a physical training scenario as an example, the corresponding target video may be a target physical training video, and the imitation video may be an imitation physical training video. As shown in FIG. 2, the large model-based video processing method according to this embodiment specifically includes the following steps:
S201: Collecting an imitation physical training video made by a user based on a recommended target physical training video;
S202: Extracting three-dimensional postures of the imitation physical training video using the large model based on the imitation physical training video;
S203: Obtaining three-dimensional postures of the target physical training video from a pre-created multimodal physical training database;

For example, the multimodal physical training database in this embodiment includes physical training data including text, video, and three-dimensional postures. During specific implementation of this step, the three-dimensional postures of the target physical training video may be directly obtained from the physical training database.

Optionally, in an embodiment of the present disclosure, before step S203, the following steps may be included:
(1) Collecting multiple physical training videos;

Specifically referring to collecting standard physical training videos from professionals.
(2) Configuring a corresponding text description for each of the physical training videos;

For example, the text description may describe the training objectives and main movement introductions of the physical training video. For instance, for a particular physical training video, the text description may include: this physical training video is a set of training movements targeting specified position A and specified position B, including multiple steps such as step 1, step 2 and step 3 for specified position A; and step 1′, step 2′ and step 3′ for specified position B.
(3) Annotating three-dimensional postures for each physical training video;

In this embodiment, a physical training video may be used to train at least one specified position of the human body, including multiple video frames. For example, specified positions may refer to any part of the human body, including shoulders, neck, elbows, knees, head, etc. For each physical training video, its three-dimensional posture may include the three-dimensional posture of nodes at movement execution positions in each physical training video frame. Based on step (2), the specified position(s) corresponding to each physical training video may be known. Therefore, this step may only annotate the three-dimensional posture of node(s) at specified position(s). Furthermore, since one specified position in the human skeleton may include many nodes, in this embodiment, for each specified position, only some representative key nodes may be selected, with each specified position including at least one key node. Therefore, for each physical training video, the three-dimensional postures may include the three-dimensional postures of the key node(s) at a specified position(s) in each physical training video frame.

This step may be specifically implemented based on hybrid inverse kinematics (hybrIK), mapping the physical training videos collected in step (1) onto a constructed human 3D skeleton structure, then converting accurate 3D joints into body part rotations through twist-swing decomposition. Specifically, swing rotation is solved through 3D joint analytical solution, while twist rotation is derived from visual cues through neural networks. Through this method, the three-dimensional postures of key nodes at specified positions in each physical training video frame may be obtained. To improve annotation accuracy, expert reviewers may review the three-dimensional postures of key nodes obtained through the above method, making timely adjustments if there are any unreasonable aspects, to annotate more accurate three-dimensional postures for each physical training video.

(4) For each physical training video, constructing multimodal physical training data based on the physical training video, corresponding text description and corresponding three-dimensional postures to obtain a multimodal physical training database.

For each physical training video, text descriptions and corresponding three-dimensional postures are collected according to the above method as a piece of multimodal physical training data and added to the multimodal physical training database. In other words, this multimodal physical training database includes information from three modalities: video, text, and three-dimensional postures of physical training, hence it is called a multimodal physical training database. The multimodal physical training database constructed through the method in this embodiment contains rich and comprehensive data, providing effective data support for video assessment by the large model.

In the scenario of this embodiment, the multimodal physical training database may be pre-input to the large model for its use. Alternatively, an access interface may be provided for the large model to call at any time.

S204: Calculating a posture difference for the three-dimensional postures of the imitation physical training video using the pre-trained large model based on the three-dimensional postures of the imitation physical training video and the three-dimensional postures of the target physical training video;

S205: Performing assessment on the imitation physical training video using the pre-trained large model based on the posture difference for the three-dimensional postures of the imitation physical training video to obtain an assessment result;

Steps S204-S205 are all completed within the large model. The large model may calculate the difference between the three-dimensional postures of the imitation physical training video relative to the three-dimensional postures of the target physical training video based on their three-dimensional postures, as the posture difference for the three-dimensional postures of the imitation physical training video. Then, based on the posture difference for the three-dimensional postures of the imitation physical training video, it may assess the effect of the imitation physical training video. For example, the assessment result may be a value between 0 to 1, where a higher value indicates that the imitation physical training video is closer to the target physical training video and the training effect is better; conversely, a lower value indicates a larger gap between the imitation physical training video and the target physical training video and a poorer training effect.

For example, step S204 may specifically include the following steps:

(a1) For each first video frame in the imitation physical training video, obtaining a three-dimensional posture difference for a keypoint at a specified position in the first video frame based on a three-dimensional posture of the keypoint at the specified position in the first video frame and a three-dimensional posture of a corresponding keypoint at a corresponding specified position in a corresponding second video frame in the target physical training video;

For ease of description in this embodiment, video frames in the imitation physical training video are called first video frames, and video frames in the target physical training video are called second video frames.

For accurate assessment in this embodiment, the imitation physical training video and target physical training video may be aligned before assessment. For example, the first frame of physical training start in the imitation physical training video may be aligned with the first frame of physical training start in the target physical training video. Then the two videos are analyzed frame by frame for comparison. For example, comparing the three-dimensional posture of a keypoint at a specified position in each first video frame of the imitation physical training video with the three-dimensional posture of the corresponding keypoint at the corresponding specified position in the corresponding second video frame of the target physical training video to obtain the three-dimensional posture difference for the keypoint at the specified position in the first video frame.

When a specified position includes multiple keypoints, the three-dimensional posture difference for each keypoint at that specified position in the first video frame may be obtained using the above method. When the first video frame includes multiple specified positions, the three-dimensional posture difference for each keypoint at each specified position needs to be obtained using the above method.

(b1) Obtaining an average value of the three-dimensional posture differences for all keypoints at all specified positions in the first video frame as a three-dimensional posture difference for the first video frame;

For example, if the imitation physical training video and the target physical training video involve physical training of two specified positions A and B, where specified position A includes three keypoints 1, 2, and 3, and specified position B includes three keypoints 4, 5, and 6. The three-dimensional posture difference D of the first video frame may be expressed by the following formula:

$$D = ( \vert {Z}_{CA 1} - {Z}_{TA 1} \vert + \vert {Z}_{CA 2} - {Z}_{TA 2} \vert + \vert {Z}_{CA 3} - {Z}_{TA 3} \vert + \vert {Z}_{CB 4} - {Z}_{TB 4} \vert + \vert {Z}_{CB 5} - {Z}_{TB 5} \vert + \vert {Z}_{CB 6} - {Z}_{TB 6} \vert ) / 6$$

Where, Z_{CA1} represents the three-dimensional posture of keypoint 1 at specified position A in the first video frame of the imitation physical training video; Z_{TA1} represents the three-dimensional posture of keypoint 1 at specified position A in the second video frame of the target physical training video aligned with the first video frame; |Z_{CA1}−Z_{TA1}| represents the three-dimensional posture difference for keypoint 1 at specified position A in the first video frame of the imitation physical training video; Similarly, |Z_{CA2}−Z_{TA2}| represents the three-dimensional posture difference for keypoint 2 at specified position A in the first video frame of the imitation physical training video; |Z_{CA3}−Z_{TA3}| represents the three-dimensional posture difference for keypoint 3 at specified position A in the first video frame of the imitation physical training video; |Z_{CB4}−Z_{TB4}| represents the three-dimensional posture difference for keypoint 4 at specified position B in the first video frame of the imitation physical training video; |Z_{CB5}−Z_{TB5}| represents the three-dimensional posture difference for keypoint 5 at specified position B in the first video frame of the imitation physical training video; and |Z_{CB6}−Z_{TB6}| represents the three-dimensional posture difference for keypoint 6 at specified position B in the first video frame of the imitation physical training video.

(c1) Obtaining a sum of all three-dimensional posture differences for all the first video frames in the imitation physical training video as a posture difference for the three-dimensional postures of the imitation physical training video.

If the imitation physical training video includes multiple first video frames, obtain the sum of the three-dimensional posture differences for multiple first video frames as the posture difference for the three-dimensional postures of the imitation physical training video.

Using the above method can accurately calculate the posture difference for the three-dimensional postures of the imitation physical training video to more objectively and accurately represent the difference between the imitation physical training video and the target physical training video.

S206: Displaying the assessment result to the user;

Specifically, the assessment result may be directly displayed on the interface of the large model-based video processing apparatus for users to view timely and understand the training effect.

S207: Generating a training improvement suggestion using the large model based on the assessment result;

Specifically, the large model may determine the quality of the imitation physical training video based on the assessment result and provide a training modification suggestion. For example, if the assessment result is greater than or equal to a first preset value, indicating excellent training effect, the generated training improvement suggestion could be: “Excellent actions, keep going!”. If the assessment result is greater than or equal to a second preset value but less than the first preset value, indicating acceptable training effect, the generated training improvement suggestion could be: “Good actions, keep practicing and try to get better.”. If the assessment result is less than the second preset value, indicating unsatisfactory training effect, the generated training improvement suggestion could be: “Unsatisfactory actions, don't be discouraged, review the target physical training video and keep practicing.” The first preset value and the second preset value mentioned above may be set according to actual situations and are not limited here. This example uses two preset values to divide into three levels, but in practical applications, the assessment results may be divided into two, four, or more levels, which is not limited here.

Optionally, in an embodiment of the present disclosure, the training improvement suggestion may be generated using the large model based on the assessment result and with reference to the three-dimensional postures of the imitation physical training video and the three-dimensional postures of the target physical training video. This allows the large model to consider more information for more accurate training modification suggestions, such as specific suggestions for particular specified positions, providing more precise guidance to users.

S208: Displaying the training improvement suggestion.

Steps S207 and S208 are supplementary opinions for further user guidance. Specifically, step S207 may be executed before step S206, and steps S206 and S208 may be displayed together.

In this embodiment, the training assessment is mainly implemented by the large model. The training assessment of this embodiment may be considered as being implemented by an assessment module set in the large model.

The assessment module in the large model needs to be trained before use. The specific training principle is similar to the application principle described above. By collecting multiple sets of target physical training videos and imitation physical training videos and annotating corresponding assessment results, the assessment module is trained to learn physical training video assessment. The specific training process may refer to relevant supervised training principles, which will not be detailed here.

With the above technical solutions, the large model-based video processing method in this embodiment can accurately and effectively assess imitation physical training videos through the large model. Moreover, it may provide accurate and reasonable training improvement suggestions based on the assessment results, providing effective guidance for users.

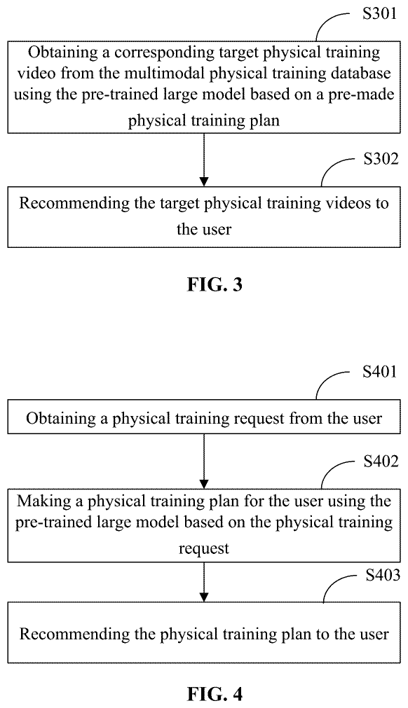

FIG. 3 is a schematic diagram according to a third embodiment of the present disclosure, providing a more detailed description based on the embodiment shown in FIG. 2. As shown in FIG. 3, the large model-based video processing method according to this embodiment specifically includes the following steps:

S301: Obtaining a corresponding target physical training video from the multimodal physical training database using the pre-trained large model based on a pre-made physical training plan; and

S302: Recommending the target physical training videos to the user.

The target physical training video in FIG. 2 could be manually pre-selected or selected through other channels. This embodiment further enriches the functionality of the large model-based video processing apparatus by adding training video recommendation capabilities.

The physical training plan in this embodiment may be pre-made manually or through other channels.

In use, the physical training plan is input to the large model, which can screen and obtain a target physical training video from the multimodal physical training database based on the physical training plan and recommend it to the user.

It is to be noted that while this embodiment uses physical training as an example, it may be applied to other training scenarios, such as dance training.

The method for recommending a target physical training video to the user in the embodiment may be implemented by directly displaying the target physical training video on the display interface of the large model-based video processing apparatus to accomplish the recommendation. Alternatively, a link to the target physical training video may be sent to the user's account through which the user logs in the large model-based video processing apparatus to accomplish the recommendation. This allows the user to view the recommended target physical training video whenever he/she logs in the account for subsequent training.

The large model-based video processing method in this embodiment mainly utilizes the large model to implement the capability of recommendation function of the target physical training videos to accomplish the recommendation of the training videos. The recommendation of training video in this embodiment may be considered as being implemented by a training video recommendation module set in the large model.

Before use, the training video recommendation module of the large model needs to be trained. The specific training principle is similar to the application principle described above. The training video recommendation module may be trained by collecting physical training plans and training videos to be recommended, so that the video recommendation module would learn how to do the recommendation. The specific training process may refer to relevant supervised training principles, which will not be detailed here.

FIG. 4 is a schematic diagram according to a fourth embodiment of the present disclosure. This embodiment further describing the technical solution in detail based on any of the embodiments shown in FIG. 2-3. As shown in FIG. 4, the large model-based video processing method according to this embodiment may specifically includes the following steps:
S401: Obtaining a physical training request from the user;
S402: Making the physical training plan for the user using the pre-trained large model based on the physical training request;
S403: Recommending the physical training plan to the user.

The physical training plan in the embodiment as shown in FIG. 3 could be pre-made manually or through other channels. This embodiment further enriches the functionality of the large model-based video processing apparatus by adding physical training plan making capabilities.

In use, the user's physical training request is input to the large model, which may make a physical training plan based on the request and recommend it to the user.

Similarly, the method for recommending the physical training plan to the user may be implemented by displaying the physical training plan directly on the display interface of the large model-based video processing apparatus to accomplish the recommendation. Alternatively, a link to the physical training plan may be sent to the user's account through which the user logs in the large model-based video processing apparatus to accomplish the recommendation. This allows the user to view the recommended physical training plan whenever he/she logs in the account for subsequent training.

It is to be noted that while this embodiment uses physical training as an example, it may be applied to other training scenarios, such as dance training.

This embodiment mainly utilizes the large model to implement physical training plan making functionality to accomplish the making of the physical training plan. The making of the physical training plan may be considered as being implemented by a physical training plan making module set in the large model.

Specifically, before use, the physical training plan making module needs to be trained. The training principle is similar to the application principle described above. The physical training plan making module may be trained by collecting physical training requests and annotated physical training plans already made, so that the physical training plan making module would learn how to make the physical training plan. The specific training process may refer to relevant supervised training principles, which is not detailed here.

Optionally, the physical training plan making module may be combined with the training video recommendation module in the embodiment as shown in FIG. 3 into one module.

It is to be noted that the large model in this embodiment may be developed, based on existing open-source language large model, by first training the model with physical literature data, and then fine-tuning using a pre-created physical training text database, combining theoretical knowledge with practical training plan making.

The physical training text database may be created through the following method:
(a2) Collecting multiple physical training documents;

The physical training documents in this embodiment may be electronic books or literature.

Using open-source tools to digitize electronic books or literature through Optical Character Recognition (OCR), converting them to text information in machine-readable txt format. Then using the large model to delete invalid content after digitization, such as information about table structure during the digitization. Optimize sentence structure and expression by the large model to obtain the final physical training documents, ensuring subsequent processing accuracy.

(b2) Generating multiple physical training knowledge Q&A pairs using a pre-trained Q&A generation model based on the training documents. Each of the multiple physical training knowledge Q&A pairs includes a physical training knowledge question and a physical training knowledge answer; and the Q&A generation model is implemented using the large model;

(c2) Constructing the physical training text database based on the multiple physical training knowledge Q&A pairs.

The Q&A generation model of this embodiment may also be implemented based on the large model. By constantly adjusting the prompt words of the large model, generate the multiple physical training knowledge Q&A pairs for the current physical training document, each physical training knowledge Q&A pair includes a physical training knowledge question and a physical training knowledge answer. The physical training knowledge Q&A pairs generated by this embodiment may be either in Chinese or in English. Moreover, it may include a single round of professional physical knowledge Q&A, or it may include multiple rounds of professional physical knowledge Q&A, and it may also include long-form Q&A.

The physical training knowledge Q&A pairs in this embodiment may include physical training requests and physical training plans. Therefore, by using the physical training text database of this embodiment to train the large model, the large model can master the basic knowledge in the field of physical training and have the preliminary function of making physical training plans. In order to further improve the efficiency of the physical training plan making module of the large model, the physical training requests and the annotated physical training plans may be further used to fine-tune the module to enhance the precision of the physical training plan making module.

The large model-based video processing method in this embodiment can effectively utilize the function of making physical training plan of large model to make physical training plans for users accurately and effectively.

Based on the above embodiments, it can be seen that in an application scenario of the present disclosure, a physical training plan making module of the large model may be used firstly to make a physical training plan for a user according to the technical solution of the embodiments shown in FIG. 4. Then, based on the made physical training plan, a training video recommendation module of the large model is used to recommend a target physical training video to the user according to the technical solution of the embodiment shown in FIG. 3. Further, based on the recommended target physical training video for the user, an assessment module of the large model is used to assess an imitation physical training video completed by the user. The above process may assist the user to complete the whole process of physical training, and the data knowledge of physical training text, video and three-dimensional postures can be integrated in the processing process. It can not only accurately and effectively develop training plans and recommend teaching videos for users, but also accurately and effectively assess users' training actions and achieve instant feedback. Thus, it can assist users to improve the training effect to the greatest extent.

Based on the above, it is to be understood that the embodiments shown in FIG. 2, FIG. 3, and FIG. 4 above may exist independently as an application scenario of the present disclosure, or may be combined together to form an application scenario of the disclosure. In practical application, they may also be combined into other application scenarios of the present disclosure. For example, the combination of embodiments shown in FIGS. 2 and 3, the combination of embodiments shown in FIGS. 2 and 4, and the combination of embodiments shown in FIGS. 3 and 4 may constitute different application scenarios of the present disclosure.

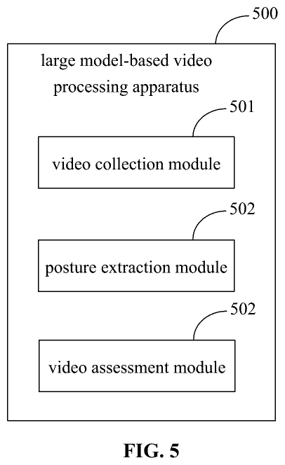

FIG. 5 is a schematic diagram according to a fifth embodiment of the present disclosure. This embodiment provides a large model-based video processing apparatus 500, including: a video collection module 501 configured to collect an imitation video made by a user based on a target video; a posture extraction module 502 configured to extract three-dimensional postures of the imitation video using a pre-trained large model based on the imitation video; and a video assessment module 503 configured to perform posture assessment on the imitation video using the pre-trained large model based on the three-dimensional postures of the imitation video and pre-obtained three-dimensional postures of the target video to obtain an assessment result.

The large model-based video processing apparatus 500 in this embodiment implements the principle and technical effect of large model-based video processing by using the above modules, which is the same as the implementation of the above related method embodiments. For details, please refer to the description of the above related method embodiments and will not be repeated here.

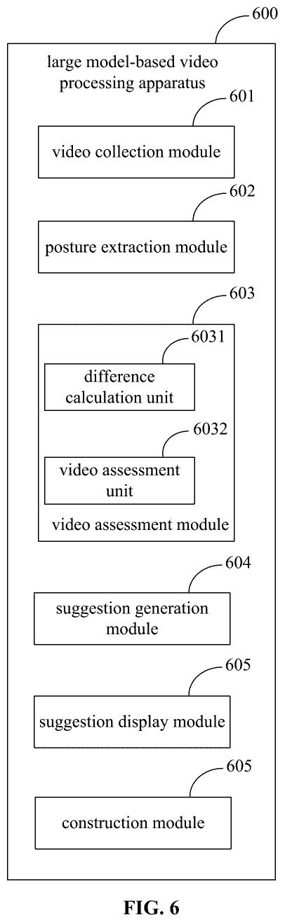

FIG. 6 is a schematic diagram according to a sixth embodiment of the present disclosure. The large model-based video processing apparatus 600, on the basis of the technical solution in the embodiment shown in FIG. 5, describes the technical solution of the present disclosure in further details. As shown in FIG. 6, the large model-based video processing apparatus 600 in this embodiments includes modules with the same names and functions as those shown in FIG. 5: a video collection module 601, a posture extraction module 602 and a video assessment module 603.

In this embodiment, the video assessment module 603 includes: a difference calculation unit 6031 configured to calculate a posture difference for the three-dimensional postures of the imitation video using the pre-trained large model based on the three-dimensional postures of the imitation video and the three-dimensional postures of the target video; and a video assessment unit 6032 configured to perform posture assessment on the imitation video using the pre-trained large model based on the posture difference for the three-dimensional postures of the imitation video to obtain the assessment result.

Optionally, in an embodiment of the present disclosure, the difference calculation unit is configured to: for each first video frame of first view frames in the imitation video, obtain a three-dimensional posture difference for a keypoint at a specified position in the first video frame based on a three-dimensional posture of the keypoint at the specified position in the first video frame and a three-dimensional posture of a corresponding keypoint at a corresponding specified position in a corresponding second video frame in the target video; determine an average value of all three-dimensional posture differences for all keypoints at all specified positions in the first video frame as a three-dimensional posture difference for the first video frame; and determine a sum of all three-dimensional posture differences for all the first video frames in the imitation video as the posture difference for the three-dimensional postures of the imitation video.

Optionally, as shown in FIG. 6, in an embodiment of the present disclosure, the large model-based video processing apparatus 600 further includes: a suggestion generation module 604 configured to generate a training improvement suggestion using the large model based on the assessment result; and a suggestion display module 605 configured to display the training improvement suggestions.

Optionally, in an embodiment of the present disclosure, the suggestion generation module 604 is configured to: generate the training improvement suggestion using the pre-trained large model based on the assessment result and with reference to the three-dimensional posture of the imitation video and the three-dimensional postures of the target video.

Optionally, in an embodiment of the present disclosure, the apparatus is applied to processing of physical training videos, the target video includes a target physical training video, the imitation video includes an imitation physical training video, and the posture acquisition module 602 is further configured to obtain the three-dimensional postures of the target physical training video from a multimodal physical training database, where the multimodal physical training database includes physical training data including text, video and three-dimensional postures.

Optionally, as shown in FIG. 6, in an embodiment of the present disclosure, the large model-based video processing apparatus 600 further includes a construction module 606 configured to: collect multiple physical training videos; configure a corresponding text description for each of the physical training videos; annotate three-dimensional postures for each of the physical training videos; construct multimodal physical training data based on each physical training video, corresponding text description and corresponding three-dimensional postures to obtain the multimodal physical training database.

The large model-based video processing apparatus 600 in this embodiment implements the principle and technical effect of large model-based video processing by using the above modules, which is the same as the implementation of the above related method embodiments. For details, please refer to the description of the above related method embodiments and will not be repeated here.

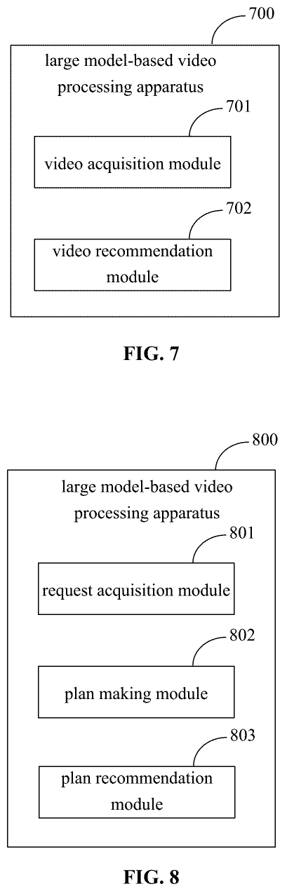

FIG. 7 is a schematic diagram according to a seventh embodiment of the present disclosure. The large model-based video processing apparatus 700 in this embodiment includes: a video acquisition module 701 configured to obtain a corresponding target physical training video from the multimodal physical training database using the large model based on a pre-made physical training plan; a video recommendation module 702 configured to recommend the target physical training video to the user.

The large model-based video processing apparatus 700 in this embodiment implements the principle and technical effect of large model-based video processing by using the above modules, which is the same as the implementation of the above related method embodiments. For details, please refer to the description of the above related method embodiments and will not be repeated here.

FIG. 8 is a schematic diagram according to an eighth embodiment of the present disclosure. The large model-based video processing apparatus 800 in this embodiment includes: a request acquisition module 801 configured to obtain a physical training request from the user; a plan making module 802 configured to make the physical training plan for the user using the large model based on the physical training request; and a plan recommendation module 803 configured to recommend the physical training plan to the user.

The large model-based video processing apparatus 800 in this embodiment implements the principle and technical effect of large model-based video processing by using the above modules, which is the same as the implementation of the above related method embodiments. For details, please refer to the description of the above related method embodiments and will not be repeated here.

It is to be understood that the embodiments shown in FIG. 7 and FIG. 8 above may be combined together to form an embodiment of the present disclosure; the embodiments shown in FIG. 7 or FIG. 8 may be combined with the embodiments shown in FIG. 5 and FIG. 6 respectively to form an embodiment of the present disclosure; and the embodiments shown in FIG. 7 and FIG. 8 together may be combined with the embodiments shown in FIG. 5 and FIG. 6 to form an embodiment of the present disclosure.

In the technical solution of the present disclosure, the acquisition, storage and application of involved user personal information are in compliance with relevant laws and regulations, and do not violate public order and good customs.

According to the embodiment of the present disclosure, there are also provided an electronic device, a readable storage medium and a computer program product.

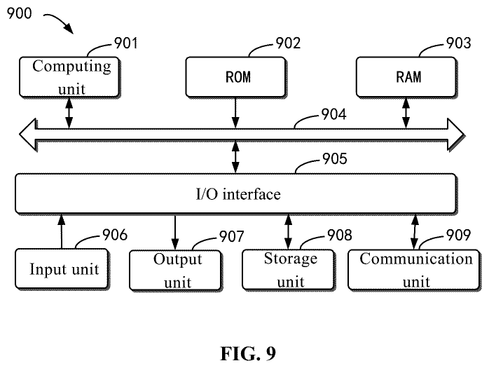

FIG. 9 shows a schematic block diagram of an exemplary electronic device 900 which may be configured to implement the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 9, the device 900 includes a computing unit 901 which may perform various appropriate actions and processing operations according to a computer program stored in a read only memory (ROM) 902 or a computer program loaded from a storage unit 908 into a random access memory (RAM) 903. Various programs and data necessary for the operation of the device 900 may be also stored in the RAM 903. The computing unit 901, the ROM 902, and the RAM 903 are connected with one other through a bus 904. An input/output (I/O) interface 905 is also connected to the bus 904.

The multiple components in the device 900 are connected to the I/O interface 905, and include: an input unit 906, such as a keyboard, a mouse, or the like; an output unit 907, such as various types of displays, speakers, or the like; the storage unit 908, such as a magnetic disk, an optical disk, or the like; and a communication unit 909, such as a network card, a modem, a wireless communication transceiver, or the like. The communication unit 909 allows the device 900 to exchange information/data with other devices through a computer network, such as the Internet, and/or various telecommunication networks.

The computing unit 901 may be a variety of general and/or special purpose processing components with processing and computing capabilities. Some examples of the computing unit 901 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 901 performs the methods and processing operations described above, such as the method according to the present disclosure. For example, in some embodiments, the method according to the present disclosure may be implemented as a computer software program tangibly contained in a machine readable medium, such as the storage unit 908. In some embodiments, part or all of the computer program may be loaded and/or installed into the device 900 via the ROM 902 and/or the communication unit 909. When the computer program is loaded into the RAM 903 and executed by the computing unit 901, one or more steps of the method according to the present disclosure may be performed. Alternatively, in other embodiments, the computing unit 901 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A large model-based video processing method, comprising:
collecting an imitation video made by a user based on a target video;
extracting three-dimensional postures of the imitation video using a pre-trained large model based on the imitation video; and
performing posture assessment on the imitation video using the pre-trained large model based on the three-dimensional postures of the imitation video and pre-obtained three-dimensional postures of the target video to obtain an assessment result.

2. The method according to claim 1, wherein performing posture assessment on the imitation video using the pre-trained large model based on the three-dimensional postures of the imitation video and pre-obtained three-dimensional postures of the target video to obtain an assessment result comprises:
calculating a posture difference for the three-dimensional postures of the imitation video, using the pre-trained large model, based on the three-dimensional postures of the imitation video and the three-dimensional postures of the target video; and
performing posture assessment on the imitation video using the pre-trained large model based on the posture difference for the three-dimensional postures of the imitation video to obtain the assessment result.

3. The method according to claim 2, wherein calculating the posture difference for the three-dimensional postures of the imitation video based on the three-dimensional postures of the imitation video and the three-dimensional postures of the target video comprises:
for each first video frame of first video frames in the imitation video, obtaining a three-dimensional posture difference for a keypoint at a specified position in the first video frame, based on a three-dimensional posture of the keypoint at the specified position in the first video frame and a three-dimensional posture of a corresponding keypoint at a corresponding specified position in a corresponding second video frame in the target video;
determining an average value of all three-dimensional posture differences for all keypoints at all specified positions in the first video frame as a three-dimensional posture difference for the first video frame; and
determining a sum of all three-dimensional posture differences for all the first video frames in the imitation video as the posture difference for the three-dimensional postures of the imitation video.

4. The method according to claim 1, further comprising:
generating a training improvement suggestion using the large model based on the assessment result; and
displaying the training improvement suggestion.

5. The method according to claim 4, wherein generating the training improvement suggestion using the large model based on the assessment result comprises:
generating the training improvement suggestion using the pre-trained large model based on the assessment result and with reference to the three-dimensional postures of the imitation video and the three-dimensional postures of the target video.

6. The method according to claim 1, wherein the method is applied to processing of physical training videos, the target video comprises a target physical training video, the imitation video comprises an imitation physical training video, and the method further comprises:
obtaining the three-dimensional postures of the target physical training video from a multimodal physical training database, wherein the multimodal physical training database comprises physical training data including text, video and three-dimensional postures.

7. The method according to claim 6, further comprising:
collecting multiple physical training videos;
configuring a corresponding text description for each of the physical training videos;
annotating three-dimensional postures for each of the physical training videos; and
constructing multimodal physical training data based on each physical training video, corresponding text description and corresponding three-dimensional postures to obtain the multimodal physical training database.

8. The method according to claim 6, further comprising:
obtaining a corresponding target physical training video from the multimodal physical training database using the large model based on a pre-made physical training plan; and
recommending the target physical training video to the user.

9. The method according to claim 8, further comprising:
obtaining a physical training request from the user;
making the physical training plan for the user using the large model based on the physical training request; and
recommending the physical training plan to the user.

10. An electronic device, comprising:
at least one processor; and
a memory communicatively connected with the at least one processor;
wherein the memory stores instructions executable by the at least one processor, and the instructions, when executed by the at least one processor, cause the at least one processor to perform a large model-based video processing method, comprising:
collecting an imitation video made by a user based on a target video;
extracting three-dimensional postures of the imitation video using a pre-trained large model based on the imitation video; and
performing posture assessment on the imitation video using the pre-trained large model based on the three-dimensional postures of the imitation video and pre-obtained three-dimensional postures of the target video to obtain an assessment result.

11. The electronic device according to claim 10, wherein performing posture assessment on the imitation video using the pre-trained large model based on the three-dimensional postures of the imitation video and pre-obtained three-dimensional postures of the target video to obtain an assessment result comprises:
calculating a posture difference for the three-dimensional postures of the imitation video, using the pre-trained large model, based on the three-dimensional postures of the imitation video and the three-dimensional postures of the target video; and
performing posture assessment on the imitation video using the pre-trained large model based on the posture difference for the three-dimensional postures of the imitation video to obtain the assessment result.

12. The electronic device according to claim 11, wherein calculating the posture difference for the three-dimensional postures of the imitation video based on the three-dimensional postures of the imitation video and the three-dimensional postures of the target video comprises:
for each first video frame of first video frames in the imitation video, obtaining a three-dimensional posture difference for a keypoint at a specified position in the first video frame, based on a three-dimensional posture of the keypoint at the specified position in the first video frame and a three-dimensional posture of a corresponding keypoint at a corresponding specified position in a corresponding second video frame in the target video;
determining an average value of all three-dimensional posture differences for all keypoints at all specified positions in the first video frame as a three-dimensional posture difference for the first video frame; and
determining a sum of all three-dimensional posture differences for all the first video frames in the imitation video as the posture difference for the three-dimensional postures of the imitation video.

13. The electronic device according to claim 10, wherein the method further comprises:
generating a training improvement suggestion using the large model based on the assessment result; and
displaying the training improvement suggestion.

14. The electronic device according to claim 13, wherein generating the training improvement suggestion using the large model based on the assessment result comprises:
generating the training improvement suggestion using the pre-trained large model based on the assessment result and with reference to the three-dimensional postures of the imitation video and the three-dimensional postures of the target video.

15. The electronic device according to claim 10, wherein the method is applied to processing of physical training videos, the target video comprises a target physical training video, the imitation video comprises an imitation physical training video, and the method further comprises:
obtaining the three-dimensional postures of the target physical training video from a multimodal physical training database, wherein the multimodal physical training database comprises physical training data including text, video and three-dimensional postures.

16. The electronic device according to claim 15, wherein the method further comprises:
collecting multiple physical training videos;
configuring a corresponding text description for each of the physical training videos;
annotating three-dimensional postures for each of the physical training videos; and
constructing multimodal physical training data based on each physical training video, corresponding text description and corresponding three-dimensional postures to obtain the multimodal physical training database.

17. The electronic device according to claim 15, wherein the method further comprises:
obtaining a corresponding target physical training video from the multimodal physical training database using the large model based on a pre-made physical training plan; and
recommending the target physical training video to the user.

18. The electronic device according to claim 17, wherein the method further comprises:
obtaining a physical training request from the user;
making the physical training plan for the user using the large model based on the physical training request; and
recommending the physical training plan to the user.

19. A non-transitory computer-readable storage medium storing computer instructions, wherein the computer instructions, when executed by a computer, cause the computer to perform a large model-based video processing method, comprising:
collecting an imitation video made by a user based on a target video;
extracting three-dimensional postures of the imitation video using a pre-trained large model based on the imitation video; and
performing posture assessment on the imitation video using the pre-trained large model based on the three-dimensional postures of the imitation video and pre-obtained three-dimensional postures of the target video to obtain an assessment result.

20. The storage medium according to claim 19, wherein performing posture assessment on the imitation video using the pre-trained large model based on the three-dimensional postures of the imitation video and pre-obtained three-dimensional postures of the target video to obtain an assessment result comprises:
calculating a posture difference for the three-dimensional postures of the imitation video, using the pre-trained large model, based on the three-dimensional postures of the imitation video and the three-dimensional postures of the target video; and
performing posture assessment on the imitation video using the pre-trained large model based on the posture difference for the three-dimensional postures of the imitation video to obtain the assessment result.
